(19) United States
(12) Patent Application Publication
(10) Pub. No.: US 2025/0361971 A1
(43) Pub. Date: Nov. 27, 2025

(54) Portable and Height-Adjustable Monitor Stand with Universal Magnetic Attachment Mechanism

(71) Applicant: Alan Joonatan Rebane, Pringi (EE)

(72) Inventor: Alan Joonatan Rebane, Pringi (EE)

(21) Appl. No.: 18/669,596

(22) Filed: May 21, 2024

(51) Int. Cl. F16M 11/04; F16M 11/14; F16M 11/24; F16M 11/28

(52) U.S. Cl. CPC F16M 11/041; F16M 11/14; F16M 11/242; F16M 11/28; F16M 2200/025

(57) ABSTRACT

A portable stand for supporting a monitor or tablet comprises a base portion with three or more foldout legs forming a tripod, a telescopic rod extending upward from the base portion, a ball head mount connected to the upper end of the telescopic rod, and a monitor support with an integrated magnet. Adhesive metal plates are configured to attach to the rear surface of the monitor or tablet, allowing it to magnetically couple with the monitor support. The stand provides a stable, height-adjustable platform suitable for various devices, enhancing portability and ease of use.

### FIELD OF INVENTION

The present invention relates generally to portable monitor and tablet stands, specifically to a height-adjustable stand with a universal magnetic attachment mechanism designed for enhancing ergonomics and portability in remote work setups.

### BACKGROUND

In the realm of portable monitor and tablet stands, several limitations in current market offerings necessitate innovation. Many existing stands lack portability due to their size and weight, often designed for stationary use in permanent workstations. These stands are generally constructed from heavy materials to ensure stability, making them cumbersome for individuals who frequently travel or need to change their work environment. Furthermore, the height adjustability of these stands is often restricted, preventing users from achieving an ergonomic setup that aligns with their specific needs.

Another significant drawback is the lack of universal compatibility in current stands. Many products on the market are tailored for specific brands or models, using proprietary attachment mechanisms that limit their usability. For example, some stands are equipped with clips that can only accommodate monitors or tablets up to a certain size, usually maxing out at around 16 inches, which excludes many portable monitors that exceed these dimensions. This proprietary nature not only restricts the choice of devices but also complicates the setup process, as users must procure brand-specific stands.

Additionally, most existing stands do not offer the flexibility to easily adjust the monitor or tablet orientation. While some stands incorporate ball joints or swivel mechanisms, they often provide limited movement, failing to support a full 360-degree rotation or secure tilting to various angles. This rigidity can hinder users from achieving optimal viewing positions, thereby affecting productivity and comfort.

The market also lacks stands that combine the necessary attributes of being foldable, lightweight, and durable while maintaining stability. Current designs often compromise on one or more of these aspects, making them less suitable for dynamic work environments. The need for a solution that balances these characteristics is evident, especially for professionals who require a portable setup that can be quickly and easily deployed.

Moreover, the ease of assembly and disassembly is a critical factor for portable stands. Many existing models are either too complex to set up, involving multiple components and steps, or too fragile, risking damage during frequent use. A stand that simplifies this process while maintaining robustness would address a significant gap in the market.

It is within this context that the present invention is provided.

### SUMMARY

The present invention provides a portable stand for supporting a monitor or tablet. The stand comprises a base portion with three or more foldout legs configured to form a tripod, a telescopic rod extending upwardly from the base portion, a ball head mount connected to the upper end of the telescopic rod, and a monitor support with an integrated magnet. Adhesive metal plates are included for attachment to the rear surface of a monitor or tablet, allowing it to magnetically couple with the monitor support.

In some embodiments, the telescopic rod comprises four extendable segments, enabling greater flexibility in height adjustment.

In some embodiments, the foldout legs of the base portion are constructed from lightweight materials such as aluminum alloy, carbon fiber, or high-strength plastic, making the stand easy to carry while maintaining durability.

In some embodiments, the ball head mount is configured to allow 360-degree rotation and tilting up to 90 degrees, providing versatile positioning options for the monitor or tablet.

In some embodiments, the portable stand includes a locking mechanism on the ball head mount to secure the monitor or tablet at a desired angle, ensuring stability during use.

In some embodiments, the integrated magnet on the monitor support is attached to the ball head mount by a screw connection, facilitating a secure and straightforward assembly.

In some embodiments, the adhesive metal plates are provided with a high-strength adhesive backing, ensuring a reliable attachment to the monitor or tablet.

In some embodiments, the portable stand includes a VESA mount option, wherein the monitor support features a detachable VESA mount compatible with industry-standard VESA patterns, offering an alternative attachment method.

In some embodiments, the foldout legs include non-slip rubber feet, enhancing stability on various surfaces and preventing unwanted movement.

In some embodiments, the monitor support is configured to support monitors or tablets weighing up to 2 kilograms, accommodating a wide range of devices.

In some embodiments, the telescopic rod is capable of extending to a height of at least 35 centimeters, providing ample adjustment for different user preferences.

In some embodiments, the base portion includes a central column that provides additional stability, enhancing the overall sturdiness of the stand.

In some embodiments, the adhesive metal plates are circular in shape with a diameter of approximately 5 centimeters, optimizing the magnetic coupling area.

In some embodiments, the monitor support is capable of holding the monitor or tablet in both landscape and portrait orientations, offering flexibility in display positioning.

In some embodiments, the foldout legs are configured to automatically lock in place when fully extended, simplifying the setup process.

In some embodiments, the telescopic rod includes one or more internal locking mechanisms to prevent unintentional retraction, ensuring the stand maintains its set height during use.

### BRIEF DESCRIPTION OF THE DRAWINGS

Various embodiments of the invention are disclosed in the following detailed description and accompanying drawings.

FIG. 1 illustrates an example of the stand in an unfolded and extended position with a metal plate ready to couple to the magnet.

FIG. 2 illustrates an example of the stand from a different angle supporting a monitor to which a metal plate has been attached via the adhesive.

FIG. 3 illustrates an example of the stand in a folded and retracted position with the magnet detached.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” indicate an acceptable degree of error or variation in measurements, usually within 20%, preferably within 10%, and more preferably within 5% of a given value or range. Numerical values provided in this description are approximate unless stated otherwise.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

As used herein, the term “portable stand” refers to any device capable of supporting a monitor or tablet in an elevated and stable position. This term is intended to encompass a variety of designs and structures, including but not limited to tripods, bipods, monopods, and other similar support systems.

The “base portion” refers to the lower part of the portable stand that provides stability. It includes one or more legs that can be folded out to form a tripod or other stable structure. The base portion may be constructed from various materials such as aluminum alloy, carbon fiber, high-strength plastic, or other durable and lightweight materials. The legs of the base portion may also include non-slip features such as rubber feet to enhance stability on different surfaces.

The term “telescopic rod” refers to an extendable and retractable rod that connects the base portion to the monitor support. The telescopic rod may comprise multiple segments that can slide relative to each other to adjust the height of the monitor or tablet. Suitable materials for the telescopic rod include aluminum, stainless steel, carbon fiber, or composite materials known for their strength and light weight. The telescopic rod may include internal locking mechanisms or external clamps to secure its extended position.

The “ball head mount” refers to a rotatable and adjustable joint connecting the telescopic rod to the monitor support. The ball head mount allows for 360-degree rotation and tilting up to 90 degrees, providing flexible positioning for the monitor or tablet. The connection between the ball head mount and the telescopic rod, as well as the connection between the ball head mount and the monitor support, may be achieved using standard screw threads, quick-release mechanisms, or other suitable attachment methods.

The “monitor support” refers to the part of the stand that directly holds the monitor or tablet. It includes a flat surface with an integrated magnet designed to couple with adhesive metal plates attached to the rear surface of the monitor or tablet. The monitor support may be constructed from materials such as metal, plastic, or composite materials and may include cushioning to protect the monitor or tablet from scratches.

The term “adhesive metal plates” refers to flat metal pieces with an adhesive backing that can be affixed to the rear surface of a monitor or tablet. These plates are designed to magnetically couple with the integrated magnet on the monitor support, allowing for a secure and detachable connection. The adhesive used may be a high-strength, pressure-sensitive adhesive, such as those manufactured by 3M, capable of providing a strong bond to various surfaces.

In some embodiments, the portable stand may include a VESA mount option. The term “VESA mount” refers to a standardized mounting interface compliant with the Video Electronics Standards Association (VESA) specifications. The monitor support may include a detachable VESA mount compatible with common VESA patterns, allowing for alternative attachment methods for monitors and tablets equipped with VESA mounting holes.

### DESCRIPTION OF DRAWINGS

The present invention relates to a portable and height-adjustable stand designed for use with monitors and tablets. This invention addresses the growing need for a versatile, ergonomic, and portable solution that enables users to maintain productivity and comfort while working remotely or in various locations. Traditional monitor stands are often bulky, heavy, and not designed for portability, limiting their practicality for users who frequently travel or need to set up temporary workstations.

The portable stand described herein offers significant improvements over existing products. It features a base portion with three or more foldout legs forming a stable tripod, a telescopic rod that allows for adjustable height, and a ball head mount that provides rotational and angular flexibility. The monitor support is equipped with an integrated magnet, and adhesive metal plates are included for secure attachment to the rear surface of a monitor or tablet. This design ensures a stable and customizable setup that can be easily packed and transported.

One of the key benefits of this invention is its portability. The foldable design and lightweight construction make it easy to carry the stand in a backpack or other compact space, allowing users to set up an ergonomic workstation wherever they go. Additionally, the telescopic rod and adjustable ball head mount enable users to position their monitor or tablet at the optimal height and angle, reducing strain and enhancing comfort during extended periods of use.

Another significant advantage is the universal compatibility of the stand. The integrated magnet and adhesive metal plates provide a simple and effective method for attaching monitors and tablets of various sizes and weights, without the need for proprietary clips or mounts. This flexibility ensures that the stand can be used with a wide range of devices, making it a versatile addition to any remote work setup.

An example configuration of the stand will now be described with reference to the drawings.

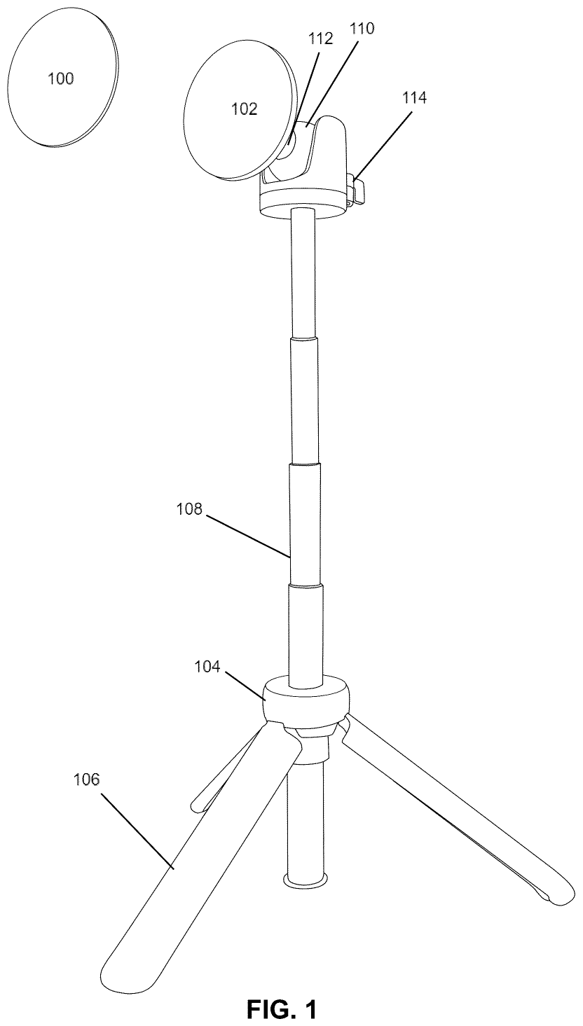

FIG. 1 depicts a perspective view of the stand in an unfolded and extended position with a metal plate 100 ready to couple to the magnet 102. The stand comprises a base portion 104 featuring three or more foldout legs 106 configured to form a tripod. The legs 106, when unfolded, form a stable tripod structure, essential for maintaining balance and support. Extending upwardly from the base portion 104 is a telescopic rod 108, shown here in its extended position. The telescopic rod 108 is composed of four segments, allowing for precise height adjustments to suit the user's ergonomic needs. The uppermost end of the telescopic rod 108 is equipped with a ball joint 110, which connects to the monitor support 112. The ball joint 110 is rotatable and adjustable, providing flexibility in positioning the monitor or tablet at various angles and orientations. The monitor support 112 incorporates an integrated magnet 102 designed to couple with the adhesive metal plate 100, which can be affixed to the rear surface of a monitor or tablet. This configuration ensures a secure attachment. Additionally, the stand includes a locking mechanism 114 on the ball joint 110 to lock the desired position and prevent unwanted movement during use.

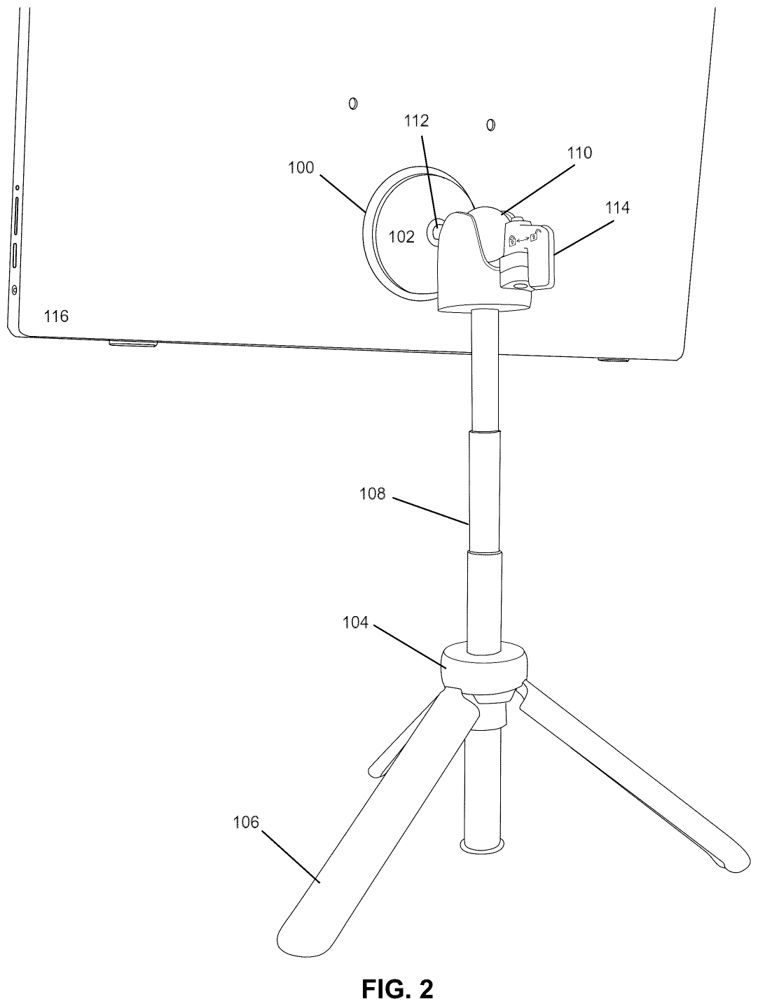

FIG. 2 shows the stand from an alternative angle, demonstrating its capability to support a monitor 116. The metal plate 100 is attached to the rear surface of the monitor 116 using a high-strength adhesive backing. The integrated magnet 102 on the monitor support 112 securely couples with the metal plate 100, holding the monitor 116 in place. The tripod legs 106, depicted here in an unfolded position, provide a stable and sturdy base, while the telescopic rod 108 supports the monitor 116 at an adjustable height, ensuring an ergonomic setup. The ball joint 110 enables the monitor 116 to rotate 360 degrees and tilt up to 90 degrees, offering versatile viewing angles. The locking mechanism 114 ensures that the monitor 116 remains in the chosen position, providing stability and preventing movement during use. This configuration highlights the universal compatibility of the stand, capable of supporting a wide range of monitors and tablets.

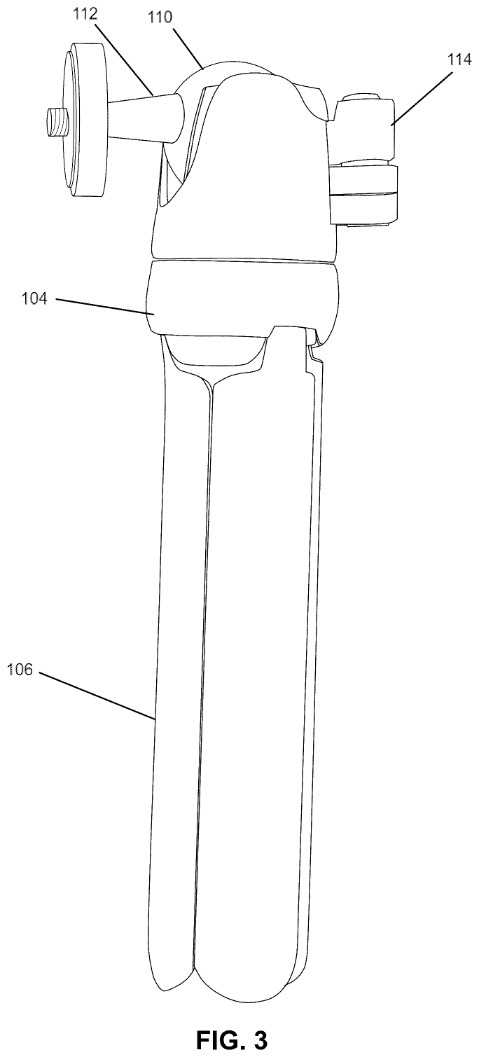

FIG. 3 illustrates the stand in a folded and retracted position with the magnet 102 detached. In this compact form, the total length of the stand is only slightly greater than the length of the tripod legs 106, making it highly portable. The base portion 104 and the telescopic rod 108 are collapsed, and the tripod legs 106 are folded together, significantly reducing the overall size of the stand. This compact and portable configuration allows the stand to fit easily into a backpack or other small carrying spaces, making it ideal for users who require a mobile and ergonomic workstation setup. The ease of transitioning between the extended and folded states emphasizes the stand's practicality and convenience for remote work environments.

The stand's components are constructed from lightweight and durable materials, such as aluminum alloy, carbon fiber, and high-strength plastic, ensuring both portability and robustness. The adhesive metal plates 100 are designed with a high-strength adhesive backing, ensuring a secure attachment to the rear surface of the monitor or tablet. The telescopic rod 108 includes internal locking mechanisms to prevent unintentional retraction, maintaining the desired height during use. The tripod legs 106 are equipped with non-slip rubber feet to enhance stability on various surfaces, preventing unwanted movement.

The design also includes a VESA mount option (not illustrated), wherein the monitor support 112 features a detachable VESA mount compatible with industry-standard VESA patterns. This alternative attachment method further broadens the stand's compatibility with different monitors and tablets.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the portable stand of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A portable stand for supporting a monitor or tablet, comprising:
a base portion having three or more foldout legs configured to form a tripod;
a telescopic rod extending upwardly from the base portion, the telescopic rod being adjustable in length and capable of maintaining a fixed position once extended;
a ball head mount connected to an upper end of the telescopic rod, the ball head mount being rotatable and adjustable in angle;
a monitor support attached to the ball head mount, the monitor support comprising a flat surface with an integrated magnet;
one or more adhesive metal plates configured to be attached to a rear surface of the monitor or tablet, each adhesive metal plate being adapted to magnetically couple with the integrated magnet on the monitor support.

2. The portable stand of claim 1, wherein the telescopic rod comprises four extendable segments.

3. The portable stand of claim 1, wherein the foldout legs of the base portion are constructed from lightweight materials selected from the group consisting of aluminum alloy, carbon fiber, and high-strength plastic.

4. The portable stand of claim 1, wherein the ball head mount is configured to allow 360-degree rotation and tilting up to 90 degrees.

5. The portable stand of claim 1, further comprising a locking mechanism on the ball head mount to secure the monitor or tablet at a desired angle.

6. The portable stand of claim 1, wherein the integrated magnet on the monitor support is attached to the ball head mount by a screw connection.

7. The portable stand of claim 1, wherein the adhesive metal plates are provided with a high-strength adhesive backing.

8. The portable stand of claim 1, further comprising a VESA mount option, wherein the monitor support includes a detachable VESA mount compatible with industry-standard VESA patterns.

9. The portable stand of claim 1, wherein the foldout legs include non-slip rubber feet to enhance stability on various surfaces.

10. The portable stand of claim 1, wherein the monitor support is configured to support monitors or tablets weighing up to 2 kilograms.

11. The portable stand of claim 1, wherein the telescopic rod is capable of extending to a height of at least 35 centimeters.

12. The portable stand of claim 1, wherein the base portion further includes a central column that provides additional stability.

13. The portable stand of claim 1, wherein the adhesive metal plates are circular in shape and have a diameter of approximately 5 centimeters.

14. The portable stand of claim 1, wherein the monitor support is capable of holding the monitor or tablet in both landscape and portrait orientations.

15. The portable stand of claim 1, wherein the foldout legs are configured to automatically lock in place when fully extended.

16. The portable stand of claim 1, wherein the telescopic rod includes one or more internal locking mechanisms to prevent unintentional retraction.
